(19) United States
(12) Patent Application Publication
(10) Pub. No.: US 2014/0350989 A1
(43) Pub. Date: Nov. 27, 2014

(54) MAINTENANCE PROCEDURE SYSTEM AND METHOD

(71) Applicant: GENERAL ELECTRIC COMPANY, SCHENECTADY, NY (US)

(72) Inventors: Mahir Erdem TELATAR, WEST MELBOURNE, FL (US); Donna O'MALLEY, WEST MELBOURNE, FL (US); Alesia SIPES, WEST MELBOURNE, FL (US); Aaron Richard MITTI, ATLANTA, GA (US)

(21) Appl. No.: 14/458,292

(22) Filed: Aug. 13, 2014

Related U.S. Application Data
(63) Continuation-in-part of application No. 14/220,198, filed on Mar. 20, 2014.
(60) Provisional application No. 61/826,144, filed on May 22, 2013.

(51) Int. Cl. G06Q 10/00; G06Q 10/10

(52) U.S. Cl. CPC G06Q 10/20; G06Q 10/1097
USPC 705/7.21

(57) ABSTRACT

Systems and methods of the invention relate to creating a schedule to perform a maintenance procedure on a client asset based on a usage of the client asset. A pre-defined interval of time to perform a maintenance procedure on a client asset and a portion of real time usage data for the client asset can be collected and/or received by an aggregation component in which a manager component can be configured to define an updated interval of time to perform the maintenance procedure based at least in part upon a comparison of the pre-defined interval of time and the real time usage date for the client asset.

### CROSS-REFERENCE TO RELATED APPLICATIONS

This application is a continuation-in-part application and claims the benefit of U.S. Non-provisional application Ser. No. 14/220,198, filed Mar. 20, 2014, and entitled “PROJECT MANAGEMENT SYSTEM AND METHOD” which claims the benefit of U.S. Provisional Application Ser. No. 61/826,144, filed May 22, 2013, and entitled “PROJECT MANAGEMENT SYSTEM AND METHOD.” The entireties of the aforementioned applications are incorporated herein by reference.

### BACKGROUND

1. Technical Field

Embodiments of the subject matter disclosed herein relate to a maintenance procedure scheduling system.

2. Discussion of Art

Schedules provide coordination between multiple workers for one or more projects. Schedules can include varying amounts of information and detail. For instance, a stream-lined schedule can include time slots and employee assignment for each particular task to work toward completion of the project. Organizing and coordinating a schedule to complete a project often includes human guesswork of complex interdependencies that can lead to ineffective schedules and deficiencies for not accounting for particular factors or data.

Unexpected repair events can impact the operational status of the railroad by limiting access to track and minimizing train velocity which leads to a negative impact on schedule adherence. Not adhering to the schedule of the railroad can cause delays in transport. In attempt to mitigate these unexpected repair events, client assets often include a manufacturer maintenance schedule with a time interval to perform such maintenance. Yet, current time-based maintenance schedules are inefficient and costly since client assets end up being maintained more often than is necessary.

It may be desirable to have a system and method that differs from those systems and methods that are currently available.

### BRIEF DESCRIPTION

In an embodiment, a method is provided that includes quantifying a condition of a client asset based at least in part on condition information. The method includes identifying a defined first interval of time to perform a maintenance procedure on the client asset. The method includes estimating a second interval of time to perform the maintenance procedure on the client asset based on a comparison between the condition of the client asset and the defined first interval of time. The method includes generating a schedule with a date to perform the maintenance procedure on the client asset based at least in part on the second interval of time.

In an embodiment, a system is provided that includes a first component configured to identify a maintenance procedure to perform on a client asset at a defined first duration of time based on a condition of the client asset that is quantified based at least in part on condition information. The first component is further configured to compare the condition of the client asset with the defined first duration of time to create a second duration of time. The system includes a second component that is configured to create a schedule with a date to perform the maintenance procedure on the client asset at the second duration of time based on the comparison of the first component or a portion of historic data representative of when the maintenance procedure was performed on two or more client assets.

In an embodiment, a system is provided that includes means for quantifying a condition of a client asset based at least in part on condition information. The system includes means for identifying a defined first interval of time to perform a maintenance procedure on the client asset. The system includes means for estimating a second interval of time to perform the maintenance procedure on the client asset based on a comparison between the condition of the client asset and the defined first interval of time. The system includes means for generating a schedule with a date to perform the maintenance procedure on the client asset based at least in part on the second interval of time.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for creating a schedule for one or more workers to participate on completing a project based on information related to the project and/or each worker;

FIG. 2 is an illustration of an embodiment of a system for adjusting a generated schedule based on real-time collected information;

FIG. 3 is an illustration of an embodiment of a system for ascertaining a number of parts or a number of workers for a project;

FIG. 4 is an illustration of an embodiment of a system for generating a schedule based on user input for a project simulation;

FIG. 5 illustrates a flow chart of an embodiment of a method for creating a schedule for one or more workers to participate on completing a project based on information related to the project and/or each worker;

FIG. 6 is an illustration of an embodiment of a system for creating a schedule for performing a maintenance procedure on a client asset;

FIG. 7 is an illustration of an embodiment of a system for leveraging data from a computer-based dispatch system to identify a date and one or more workers to perform a maintenance procedure on a client asset; and

FIG. 8 illustrates a flow chart of an embodiment of a method for creating a schedule to perform a maintenance procedure on a client asset.

### DETAILED DESCRIPTION

Embodiments of the invention relate to methods and systems for creating a schedule to perform a maintenance procedure on a client asset based on a usage of the client asset. A pre-defined interval of time to perform a maintenance procedure on a client asset and a portion of real time usage data for the client asset can be collected and/or received by an aggregation component in which a manager component can be configured to define an updated interval of time to perform the maintenance procedure based at least in part upon a comparison of the pre-defined interval of time and the real time usage date for the client asset. The manager component can further leverage additional data and/or databases to adjust the updated interval of time to perform the maintenance procedure, identify a preventative maintenance procedure to perform on the client asset, schedule a date to perform the maintenance procedure and/or preventative maintenance, identify one or more workers to perform the maintenance procedure and/or preventative maintenance on the date scheduled, among others.

The subject innovation can include a system (e.g., systems 100, 200, 300, 400, 600, 700, for example) that is configured to collect and manage client asset condition data as well as a method(s) (e.g., method 500, 800) to handle maintenance scheduling (e.g., predictive and defined due to a condition). The system can utilize data from an Automated Train Dispatching System (ADS, for instance and others as discussed below), Precision Dispatch System (PDS, for instance and others as discussed below), or other computer-based dispatching system as well as data from other sources (such as, but not limited to, weather services, field equipment manufacturers, the railroad operator, users, data stores, networks, data bases, cloud-based storage, and the like) to identify the times to perform maintenance procedures on client assets. The system can further predict the times to perform maintenance procedures to afford preventative maintenance. The system can factor in criteria such as, but not limited to, labor costs, labor scheduling, train scheduling, maximum time to failure, equipment condition, among others (discussed in more detail below). By optimizing a maintenance schedule, a railroad system can save costs (e.g., cut costs by ½ to ⅔) of the maintenance program. A usage based maintenance schedule can also minimize catastrophic equipment failures as the equipment can be maintained rather than repaired. This can reduce the amount of time the track is out of service and increase the volume of the railroad.

With reference to the drawings, like reference numerals designate identical or corresponding parts throughout the several views. However, the inclusion of like elements in different views does not mean a given embodiment necessarily includes such elements or that all embodiments of the invention include such elements.

The term “component” or “engine” as used herein can be defined as a portion of hardware, a portion of software, or a combination thereof. A portion of hardware can include at least a processor and a portion of memory, wherein the memory includes an instruction to execute. The term “cut-over” as used herein can be defined as a period of time in which a testing phase for a project ends and a regular use period for the project begins. The term “build” as used herein can be defined as a period of time in which a construction phase for a project begins and a testing period begins for the project. The term “test” as used herein can be defined as a period of time between a construction phase for a project and a cutover phase of the project. The term “client asset” as used herein can be defined as a fixed asset (e.g., structure, portion of software, portion of hardware, and the like) or a mobile asset (e.g., vehicle, and the like) that is owned and/or operated by a client entity such as, for example, a railroad, a power generation company, a shipping company (e.g., land, sea, air, and/or an combination thereof), a mining equipment company, an airline, or another asset-owning and/or asset-operating entity. A client asset can also be a vehicle, a part of a vehicle, a rail asset, a part of a rail system, a part of a rail system that the vehicle uses, a device that monitors a vehicle or a rail system, among others. The term “structure” as used herein can be defined as a man-made structure or a machine such as, for example, a building, a crane, or a bridge, among others. The structure can be inspected in order to ensure integrity for one or more parts that comprise the man-made structure or the machine. The term “vehicle” as used herein can be defined as an asset that is a mobile machine that transports at least one of a person, people, or a cargo. For instance, a vehicle can be, but is not limited to being, a rail car, an intermodal container, a locomotive, a marine vessel, mining equipment, a stationary power generation equipment, industrial equipment, construction equipment, and the like. The term “part” as used herein can be defined as a portion of a client asset, a portion of a structure, and/or a portion of a vehicle, wherein the “part” is involved in a repair, construction, testing, or maintenance related to at least one of the client asset, the structure, or the vehicle. The term “ownership” as used herein can be defined as proof of legal claim to property such as a vehicle, a structure, a client asset, and the like. The proof can be a title, a lease agreement, a contract, a legal document, a purchase agreement, among others. The term “project” as used herein can be defined as a job that a portion of a resource is assigned to at least one of build, test, cut-over, maintain, service, deconstruct, or a combination thereof. In an example, the project can include a maintenance procedure on a client asset. The resource can be, for instance, a part, a client asset, a structure, a vehicle, and the like. The term “crew” as used herein can be defined as one or more workers that participate on a project. The term “urgent repair” as used herein can be defined as a repair that is required on a client asset in order for the client asset to be usable. The “urgent repair” can be one performed on a client asset that is no longer working, broke, damaged to a point of not being able to perform the function the client asset was intended to perform, and the like. The term “preventative maintenance” as used herein can be defined as a repair on a client asset that is not required in order for the client asset to be usable or perform the function the client asset was intended to perform. The term “severe weather” as used herein can be defined as a weather condition that can pose a threat of injury to life and/or property. “Severe weather” includes weather conditions such as, but not limited to, tropical cyclones, hurricanes, snowstorms, ice storms, wind storms, high winds (e.g., greater than 55 miles per hour), blizzards, flooding, heat waves, thunderstorms, lightening, tornadoes, hail, heavy rain, and the like. The term “similar” is used herein to categorize two or more client assets, wherein two or more client assets are “similar” and are defined as performing an identical function or resembling function. For instance, a first client asset and a second client asset can be similar if the identical function or resembling function is performed by each. Further, the first client asset and the second client asset can perform the identical function or resembling function independent of a type, a model, a brand, a manufacturer, etc. of each client asset.

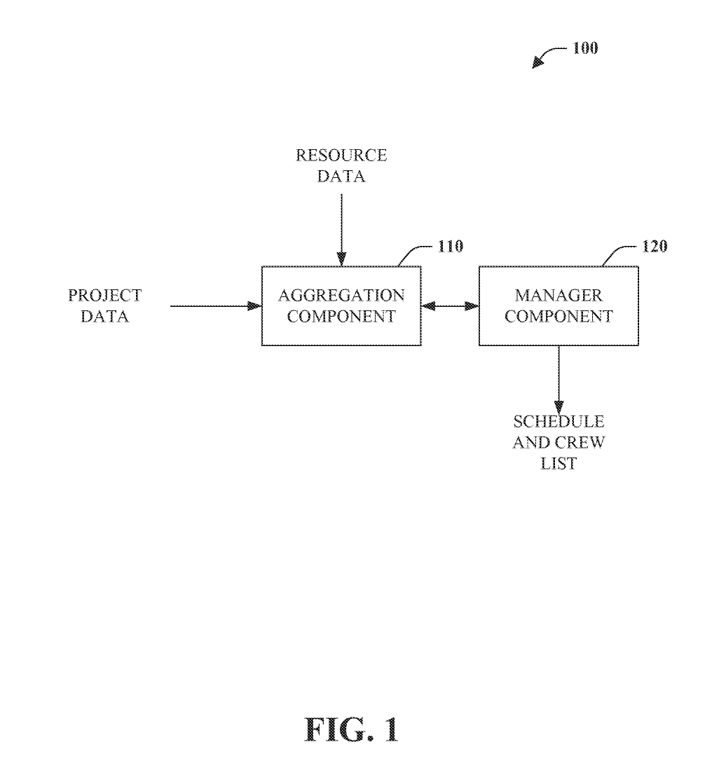

FIG. 1 is an illustration of a system 100 for creating a schedule for one or more workers to participate on completing a project or maintenance procedure based on information related to the project and/or each worker, and/or client asset data or maintenance data. The system includes an aggregation component 110 that is configured to collect and/or receive at least one of a portion of project data or a portion of resource data. A manager component 120 is configured to create a schedule based on the portion of project data or the portion of resource data. The schedule can include an assignment of one or more workers to a project on a particular date or time in light of an evaluation of the portion of project data or the portion of resource data (e.g., via the aggregation component). A list of workers (e.g., also referred to as a crew list) and respective assignment dates and/or times can also be created by the manager component based on the evaluation of the portion of project data and/or the portion of resource data. In an embodiment, the manager component can receive or calculate an estimated amount of time to complete the project that can be used to generate the schedule. For example, the estimated amount of time can be pre-defined (e.g., manually set), based upon a previous project (e.g., comparison to historic data related to projects), or determined based on evaluation of tasks (e.g., a project can include a set of tasks), parts, equipment, type of project, among others. In an embodiment, the system can evaluate a project and a disparate project to generate a schedule. For instance, the disparate project can be a project that has been completed, an ongoing project (e.g., not completed), and the like. The system can leverage historical data of other projects to schedule a project to improve scheduling in light of previous situations, data, criteria, and the like.

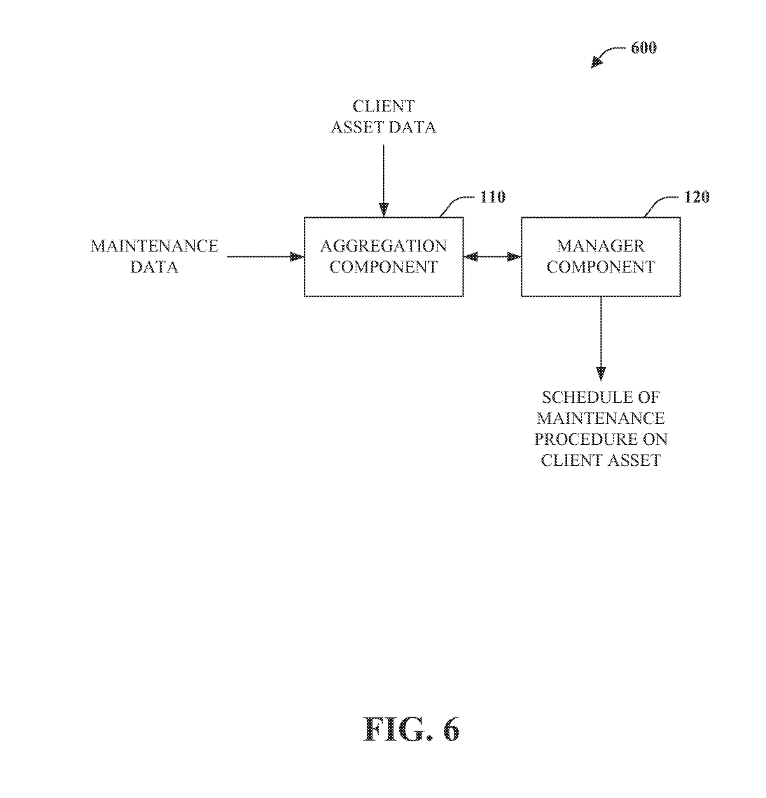

In another embodiment, discussed in at least FIGS. 6-8, the aggregation component and the manager component can be configured to create a schedule to perform a maintenance procedure on a client asset. In such an embodiment, the aggregation component can be further configured to collect and/or receive at least a portion of maintenance data or client asset data. Also in such embodiment, the manager component can be further configured to create a schedule to perform a maintenance procedure on a client asset.

By way of example and not limitation, the portion of project data can be data associated with the project such as, but not limited to, a geographic location of the project, a priority of the project, a cost of the project, a dispatch requirement of the project, a resource lead time for the project, a part related to the project, a shipment of a part for the project, and the like. For example, the portion of resource data can be, but is not limited to being, data associated with a resource for a project such as a worker, an employee, a contractor, equipment, tools, a part, among others. In an embodiment, the portion of resource data can relate to employee information, wherein the employee information relates to at least one of a shift schedule of the employee, a union requirement, an expertise of the employee, a geographic location of the employee, a suspension for the employee, a vacation time of the employee, an hourly rate of the employee, an experience on a previous project, and the like.

For instance, a group of employees that are available at a time (e.g., available in that the employees are not assigned to a project at the time) can be evaluated for a project in which a subset of the employees can be assigned to the project in light of available working hours, hourly rates, skill sets, geographic proximity, type of project, among others. The schedule created can include an appropriate amount of workers to complete the project within a desired time frame. For instance, if the time frame is shortened, the system can increase at least one of a number of workers assigned to the project, the number of hours assigned to one or more workers, the number of hours to work each date, the days to work for each worker, among others.

It is to be appreciated that the system 100 can be further utilized to identify a maintenance schedule for a client asset that defines when a maintenance procedure is to be performed. In particular, the manager component 120 can be configured to identify a schedule to perform a maintenance procedure on the client asset based on data received and/or collected by the aggregation component 110, wherein the data can be, but is not limited to being, maintenance data, client asset data, condition information, among others. The subject innovation can be gathering information from one or more databases. The system(s) can develop one or more algorithms using the data gathered to create a maintenance schedule for different equipment. The maintenance schedule can be for predictive maintenance or for maintenance that is based on a condition. The maintenance schedule created can be more cost effective, performed when it is needed, performed where it is needed, and the performance can be based on an actual need rather than a duration of time. The system can collect data such as, but not limited to, product manufacturer maintenance guidelines, Federal Railroad Administration (FRA) scheduled maintenance requirements, scheduled maintenance requirements, recent or log of repair dates on the asset, weather conditions, recent or log of maintenance dates on the asset, client asset data related to use, among others. The system provided herein can create a maintenance schedule that lowers cost by increasing equipment readiness, effectively using maintenance personnel and equipment, radically lowers catastrophic equipment failures, among others. These features and elements are further explained below in at least FIGS. 6-8, among others.

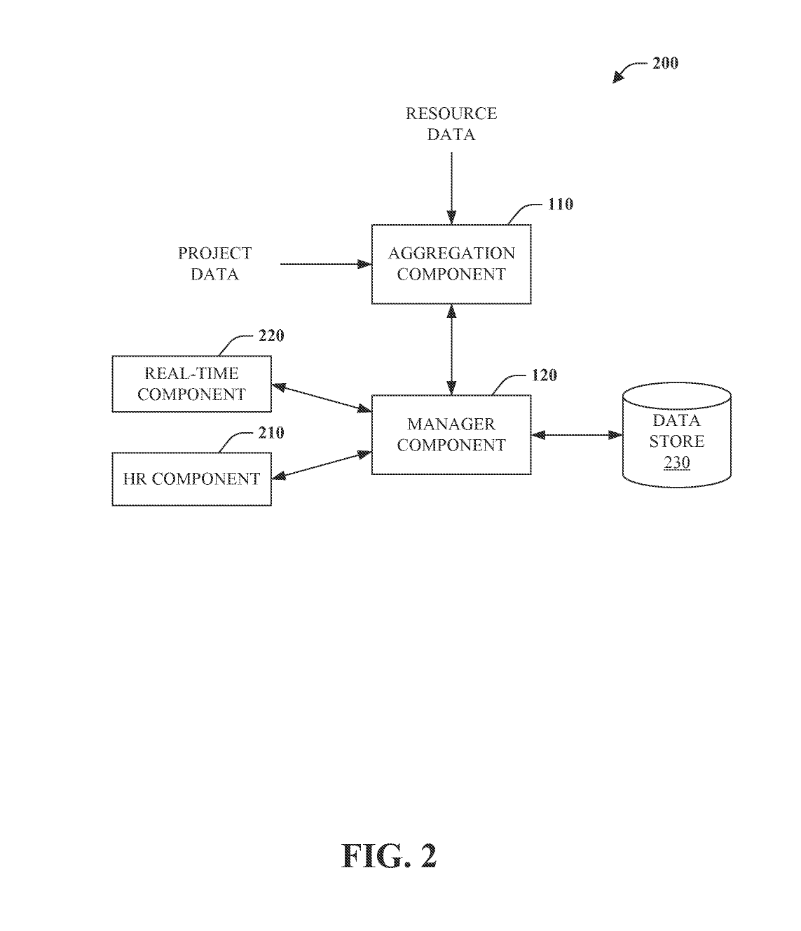

FIG. 2 is an illustration of a system 200 for adjusting a generated schedule based on real-time collected information. The aggregation component can evaluate a portion of project data and/or a portion of resource data to identify factors associated with a worker (e.g., that may work on one or more projects) or a project (e.g., that is to be completed and workers are to be assigned) or a maintenance procedure. The manager component can create a schedule for a period of time (e.g., a duration of time to complete the project or a portion of the project such as a task) that assigns available workers for dates to complete the project or task or maintenance procedure within the period of time. The manager component and/or the aggregation component can consider numerous factors related to the project and/or maintenance procedure and/or the workers (referenced above).

The system includes a Human Resources (HR) component 210 (herein referred to as “HR component.”). The HR component is configured to identify a pool of workers available to assign to a project based on an additional need for the project. For instance, a project may have a timeline shortened to complete sooner and additional workers may be needed. In light of this need, the HR component can identify or contact potential workers for the project (e.g., workers with a skill set particular for the project, newly available workers, among others). The HR component leverages one or more workers outside a set of workers evaluated with resource data based on the set being used and evaluated already. For example, resource data can be related to a set of workers (e.g., employed, contracted, independent contractor, among others) and the schedule can use a subset of the set of workers. In light of a change to the schedule or the project, more workers can be identified from an additional set of workers (e.g., stand-by workers, part-time employees, among others).

The HR component can be further configured to identify a pool of workers available to assign to perform a maintenance procedure on a client asset. For instance, a maintenance procedure may be needed to be performed on a schedule created based on evaluating the maintenance data and/or client asset data. In light of this evaluation and/or comparison, the HR component can identify or contact potential workers for the performance of the maintenance procedure (e.g., workers with a skill set particular for the procedure, newly available workers, workers located in the geographic proximity of the location to perform the maintenance, workers with availability, among others). The HR component leverages one or more workers outside a set of workers evaluated with resource data based on the set being used and evaluated already. For example, resource data can be related to a set of workers (e.g., employed, contracted, independent contractor, among others) and the maintenance procedure can be performed with a subset of the set of workers. In light of a change to the maintenance procedure or the created schedule to perform the maintenance procedure, more workers can be identified from an additional set of workers (e.g., stand-by workers, part-time employees, among others).

The system includes a real-time component 220 that is configured to adjust the generated schedule in real-time, wherein the adjustment can relate to an assigned date, an assigned employee, a start date of the project, a projected end date of the project (e.g., handle projects running late or behind schedule to affect downstream projects or portions of projects), an end date of the project, a start date of a maintenance procedure, a projected end date of the maintenance procedure, an end date of the maintenance procedure, among others. The real-time component receives or aggregates information related to changes or adjustments in real-time and/or with minimal delay. By way of example and not limitation, the changes or adjustments can relate to an addition or subtraction of a worker on a project (e.g., hired worker for the project, worker leaves sick, worker calls in sick, worker termination, among others), the start or end date, a delivery of a part for the project, a delivery of a part for the maintenance procedure, a duration of time for transport of the client asset to a location to perform the maintenance procedure, weather, among others.

In an embodiment, the real-time component can generate an update in response to a change in status of an input value (e.g., information related to changes or adjustments, resource data, project data, and the like). For instance, if an employee already assigned to a crew (e.g., for the project and/or the maintenance procedure) becomes unavailable (certification lapses, gets ill, etc.), the real-time component can generate an updated crew list via an electronic communication to the real-time component, component, and/or controller/microprocessor incorporated with the system. In another embodiment, the update can be a “push” update that is directly communicated to a device, system, component, controller, and/or microprocessor.

For example, a weather condition that affects a project (e.g., weather condition limits work to be performed, etc.) or maintenance procedure can be accounted for by the real-time component by adjusting the schedule such that one or more workers can be rescheduled to a date with more favorable weather to perform work for the project and/or the maintenance procedure. In such example, the weather condition or weather alert can be received and the real-time component can generate a modified schedule and/or a notification indicating that the assigned one or more workers on the project or maintenance procedure can stop work on the project or maintenance procedure for that time and be rescheduled at a different time when the weather is more suitable to perform work on the project or the maintenance procedure.

In another example, a worker assigned to a project or maintenance procedure can call in sick or call off work or leave work early. The real-time component can modify the schedule and assigned workers on a project or maintenance procedure in light of such changes. In such example, the real-time component can request additional worker(s) (e.g., via the HR component) or increase a scheduled work time for the remaining workers on the project or maintenance procedure. For instance, the real-time component can receive indicators that can trigger an adjustment or modification to the schedule, assigned workers, the dates and/or times the workers are to work on the project or maintenance procedure, or the timeline (e.g., start date, end date, date of completion, etc.) of the project or maintenance procedure. In another example, a due date for completion of the project or maintenance procedure can be moved to a later date in which the real-time component can trigger the manager component to update the schedule to reduce the amount of workers on the project or maintenance procedure and/or reduce the amount of time the workers are to work on the project or maintenance procedure. In such example, the manager component can further use the extra workers (e.g., extra based on the due date moved to a later time) or the extra amount of time of the workers on another project or another maintenance procedure.

In an embodiment, the real-time component can communicate with a time clock for one or more workers with a project or maintenance procedure. For instance, each employee can clock in and clock out which allows monitoring of work hours for particular portions of a project or maintenance procedure to facilitate tracking progress. In another embodiment, the real-time component can be accessed by a supervisor, a manager, or a user managing one or more workers on the project or maintenance procedure to input and/or communicate a change or update to the schedule, the project, the maintenance procedure, or one or more workers.

In an embodiment, the aggregation component and/or the manager component or other discussed components or elements (e.g., real-time component, HR component, scenario engine, part predict component, labor predict component, among others) stores information related to the systems 100, 200, 300, and/or 400 (and/or method 500) with a data store 230. The data store can include information such as, but not limited to, project data, resource data, estimated amount of time to complete a project, project completion time, cost data (e.g., part cost, project cost, employee cost, worker cost, among others), part ordering data, delivery data, equipment data, client asset data, maintenance data, condition information, maintenance procedure data, estimated amount of time to complete a maintenance procedure, maintenance procedure completion time, cost data (e.g., part cost, maintenance procedure cost, employee cost, worker cost, among others), among others, and/or a suitable combination thereof.

It is to be appreciated that the data store can be, for example, either volatile memory or nonvolatile memory, or can include both volatile and nonvolatile memory. The data store of the subject systems and methods is intended to comprise, without being limited to, these and other suitable types of memory. In addition, it is to be appreciated that the data store can be a server, a database, a hard drive, a flash drive, an external hard drive, a portable hard drive, a cloud-based storage, and the like. The data store can be a stand-alone component (as depicted), incorporated into the manager component, incorporated into the aggregation component, or a combination thereof.

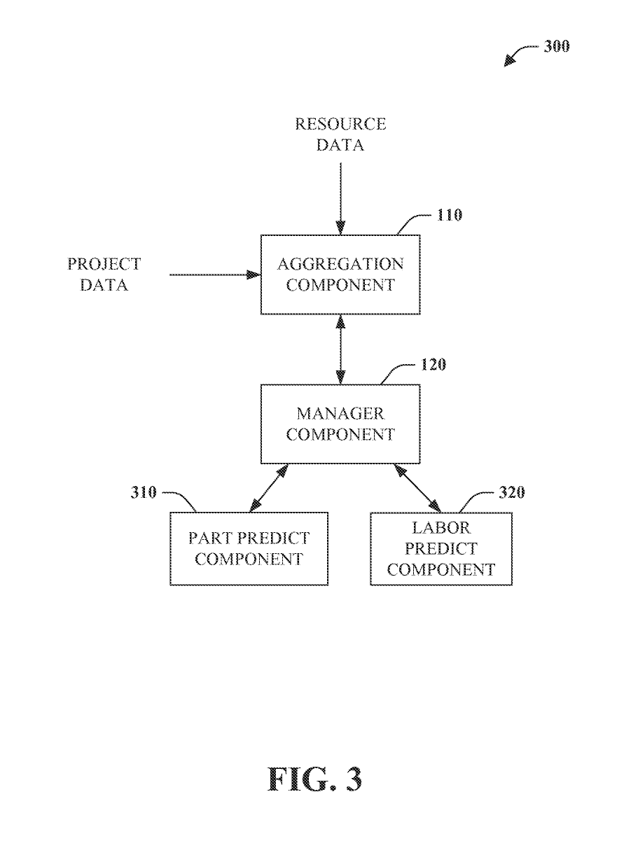

FIG. 3 is an illustration of a system 300 for ascertaining a number of parts or a number of workers for a project and/or the performance of a maintenance procedure. The system includes a part predict component 310 that is configured to manage an inventory of parts based on one or more projects and/or performance of a maintenance procedure. The part predict component leverages the portion of project data and/or a portion of resource data to identify a part utilized with the project and whether the part or quantity of parts are available at a time for the project, wherein the time is a date or time the part is needed to perform work on the project. Further, the part predict component leverages the portion of maintenance procedure data and/or a portion of client asset data to identify a part utilized with the maintenance procedure and whether the part or quantity of parts are available at a time for the start of the maintenance procedure, wherein the time is a date or time the part is needed to perform the maintenance procedure on the client asset. The part predict component can be a stand-alone component (as depicted), incorporated into the manager component, incorporated into the aggregation component, incorporated into the labor predict component, or a combination thereof.

For instance, the part predict component can order one or more parts based on a generated schedule and/or a part used for a portion of the project or maintenance procedure scheduled. In an embodiment, the part predict component can automatically manage an inventory of parts for one or more projects or maintenance procedures in which purchases or re-supplying of one or more parts can be based upon a use in a project, a use for a maintenance procedure, a time of the project (e.g., a start time, an end time, a due date of the project), a time of the maintenance procedure, a priority of the project or maintenance procedure, a depletion of a part inventory, a portion of a project or maintenance procedure to be completed, a delivery date of a part, a delivery time of a part, and the like.

In an embodiment, the part predict component can be leveraged by the manager component to facilitate creating the schedule for the project or the maintenance procedure. For instance, the part predict component can generate a part(s) list in which an estimated delivery time (e.g., shipping time, order time, ship to site time, ship to project location time, among others, including consideration of supply chain and storage requirements and limitations) can be provided, wherein the manager component can factor the estimated delivery time into the created schedule (e.g., target due date, start date, end date, projected date, start date for a portion of a project, among others) for the project or the maintenance procedure.

The system includes a labor predict component 320 that is configured to estimate at least one of a number of workers for a project or maintenance procedure or an amount of hours to perform for a project or maintenance procedure based on the portion of project data. In an embodiment, the labor predict component can evaluate the portion of project data to indicate or adjust the number of workers to assign or schedule for a project or maintenance procedure and/or the amount of work force (e.g., man-hours, equipment use, parts, among others). For instance, a project involving a structure “A” can be previously performed and leveraged to identify an amount of workers or hours needed to complete. In another instance, a maintenance procedure on a client asset can be previously performed and leveraged to identify an amount of workers or hours needed to complete. The labor predict component can utilize such historical data related to projects or maintenance procedures to identify factors to generate the schedule or assign one or more workers to the project or the maintenance procedure. The labor predict component can be a stand-alone component (as depicted), incorporated into the manager component, incorporated into the aggregation component, incorporated into the part predict component, or a combination thereof.

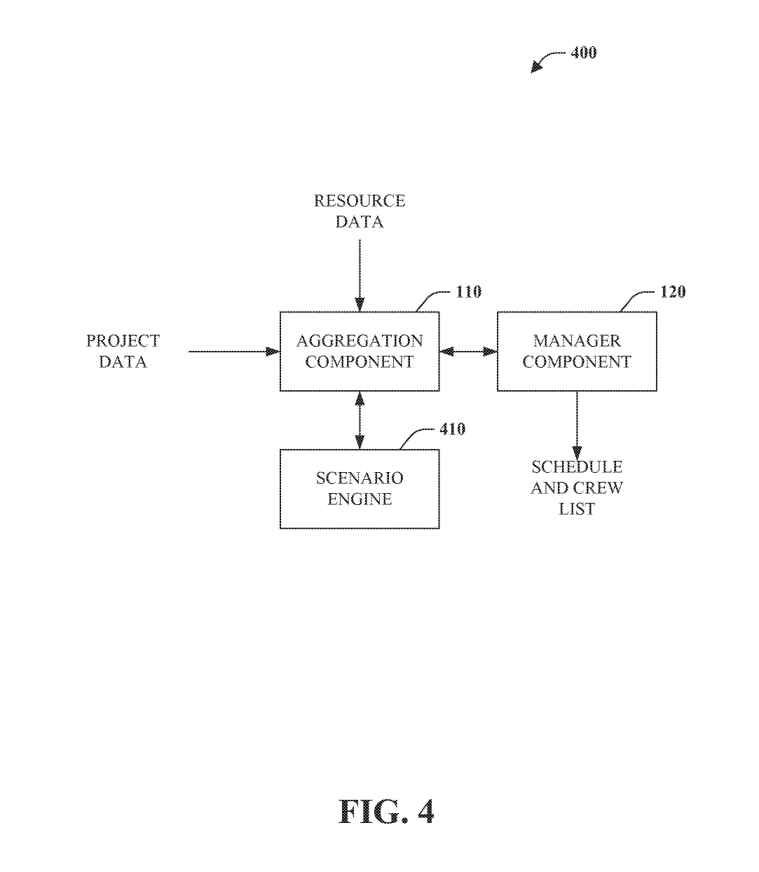

FIG. 4 is an illustration of a system 400 for generating a schedule for a project or to perform a maintenance procedure based on user input for a project simulation. The system includes a scenario engine 410 that is configured to generate a schedule or a crew list (e.g., one or more workers assigned) to a project or a maintenance procedure based on received or collected data such as, client asset data, condition information, maintenance data, project data, or resource data. In an embodiment, the scenario engine allows evaluation of situational data that is based on a real-life project, a fabricated project, a simulated project, a real-life maintenance procedure, a fabricated maintenance procedure, a simulated maintenance procedure, among others. For instance, a user can provide a portion of project data or a portion of resource data based on a hypothetical scenario, wherein the scenario engine can generate a schedule or crew list for such scenario based on historical information based on real-life projects. For instance, a user can provide a portion of data related to a maintenance procedure on a client asset or a portion of maintenance procedure data based on a hypothetical scenario, wherein the scenario engine can generate a schedule or crew list for such scenario based on historical information based on real-life maintenance procedures on the client assets. The scenario engine can be a stand-alone component (as depicted), incorporated into the aggregation component, incorporated into the manager component, or a combination thereof.

In an embodiment, project data and/or resource data for each project can be collected and categorized based on details related thereto. In an embodiment, client asset data, maintenance procedure data, and/or condition information for each maintenance procedure can be collected and categorized based on details related thereto. Based on this categorization and collected data, query information (e.g., user-input related to a scenario or simulation) can be matched to substantially similar information collected and/or categorized. The scenario can be matched to previous projects or maintenance procedures or historical data to generate a schedule or crew list representative of a projected outcome for the project or maintenance procedure. In another embodiment, the use of on-going or upcoming projects or maintenance procedures, schedules, or crew lists can be employed in order to facilitate prediction of simulations or hypothetical project or maintenance procedure scenarios.

Turning to FIG. 6, a system 600 is illustrated that includes the manager component 120 that is configured to quantify a condition from condition information in order to create a schedule for a maintenance procedure for a client asset, wherein the schedule mitigates failures for the client asset. For instance, mean time between failures and/or mean distance between failures is increased by utilizing the system 600. It is to be appreciated that the systems 100, 200, 300, and 400 can be configured to create a schedule to perform a maintenance procedure on an asset and/or assign one or more workers to perform the maintenance procedure. Moreover, the system 600 can be utilized to preemptively schedule a maintenance procedure on a client asset based on data such as, but not limited to, client asset data, maintenance data, condition information, among others.

The system 600 can include the aggregation component 110 that is configured to collect and/or receive client asset data, maintenance data, and/or condition information related to a client asset. The manager component can utilize such data to generate a schedule to perform a maintenance procedure on the client asset. In a particular example, the manager component can be configured to create a schedule to perform one or more maintenance procedures on a client asset based on a condition or a usage of the client asset. For example, a first client asset that is used more often than a second client asset may require a maintenance procedure to be performed on the first client asset before the second client asset and at an earlier time then a time-based maintenance scheduling. In an embodiment, the manager component can create or update a schedule to perform a maintenance procedure based on historical data related to the client asset, similar client assets, similar maintenance procedures performed on other client assets, a combination thereof, and the like.

In an embodiment, the schedule can include, but is not limited to including, a date, a time, an interval of time, an amount of time, one or more workers to perform the maintenance procedure, an assignment of one or more workers to perform the maintenance procedure, an ordering of one or more parts to perform the maintenance procedure, a geographic location to perform the maintenance procedure, and the like.

For example, the manager component can receive a defined first time to perform a maintenance procedure on a client asset, wherein data (e.g., condition information, client asset data, historic data, maintenance data, and the like) received by the aggregation component can be used to create a second time at which to perform the maintenance procedure on the client asset. It is to be appreciated that the first time or the second time can reference at least one of an amount of time, a time of day, a date, a calendar date, and the like.

The manager component can further leverage data from one or more systems to create an updated time or schedule to perform a maintenance procedure on or for a client asset. As discussed below, a computer-based dispatch system can be used to collect data related to one or more client assets (e.g., railway system, vehicle, part of a vehicle, part of a railway, devices that monitor a vehicle, devices that monitor a railway system, wayside equipment, among others). Data from such computer-based dispatch system(s) can be used by the manager component to create or update a schedule to perform a maintenance procedure on a client asset and/or assign one or more workers to perform the maintenance procedure on the client asset in accordance with the created schedule. In another example (discussed in more detail below), the manager component can leverage a weather database that includes information about weather conditions that can impact a client asset condition. Based on such data on weather conditions, maintenance procedure(s) can be scheduled earlier (if client asset exposed to severe weather) or later (if client asset not exposed to severe weather) due to the affect on wear of the client asset. For example, severe heat can cause rail bending in which the manager component can create a schedule for a maintenance procedure on the rail in light of such severe weather condition. In another example, a lightning strike can damage a client asset, wherein the manager component can create a schedule for a maintenance procedure based thereon.

The aggregation component can collect and/or receive maintenance data. The receipt or collection can be via a database, a data store, a cloud-based network, a network, a user input, an electronic communication, a website, and the like. The maintenance data can be, but is not limited to, a type of maintenance procedure, a maintenance procedure for a client asset, a time interval to perform a specific maintenance procedure for a client asset, instructions on how to perform the specific maintenance procedure, historic data related to performance of a maintenance procedure on a type of client asset, a part used for the performance of a maintenance procedure, a manufacturer defined usage of the client asset to perform a maintenance procedure, a tool used to perform the maintenance procedure, a location on where to perform the maintenance procedure, one or more worker to perform the maintenance procedure, and the like.

The aggregation component can further collect and/or receive client asset data, wherein the receipt and/or collection can be via a database, a network, a user input, an electronic communication, a cloud-based network, a data store, and the like. The client asset data can be, but is not limited to being, type of client asset, location of client asset, model information of the client asset, historic data related to maintenance procedures performed on the client asset, data representative of a parameter of the client asset, hours used, mega-watt hours, power produced, a metric to measure a use of the client asset, distance used, location of use for the client asset, weather conditions the client asset has experienced, cost to replace client asset, purchase price of the client asset, and the like. It is to be appreciated that the manager component can evaluate the client asset data to identify a condition of the client asset based on condition information, wherein the condition information is any suitable information associated with a client asset.

In still another embodiment, the manager component can create a schedule to perform a maintenance procedure on a client asset and/or assign one or more workers to perform the maintenance procedure based on data such as, but not limited to, a train schedule, delivery times of commodities, type of good on the vehicle, type of cargo, electronic signal response time for a device, a vehicle schedule, a workforce, a geographic location, a track class of a vehicle (e.g., Class 1 track, Class 2 track, Class 3 track, Class 4 track, and/or Class 5 track), commodity information (e.g., scheduled delivery date, recipient information, sender information, type of cargo, whether integrity of cargo is compromised by time, cost of shipment, economic evaluation of loss of profit for delay of shipment, etc.), autonomous data (e.g., real time track or rail monitoring, data collection systems, etc.), load balancing of a rail system, and the like.

As discussed, the manager component can identify a condition for a client asset based on data collected and/or received, wherein such condition can be utilized to create a schedule to perform a maintenance procedure on the client asset.

The system can create a displayable graphic (e.g., image, graph, numeric ranking, portion of a graphic, portion of text, etc.) for a client asset related to a type of use and/or a condition of the track over which the client asset has been used. For instance, the manager component can assign a condition value to a location of the client asset use or a portion of a railroad track, wherein the condition value is used to adjust the evaluation of when to perform a maintenance procedure on the client asset. The condition value can be used by the manager component to perform the maintenance procedure earlier than scheduled (e.g., condition of use translates into excessive use compared to a baseline amount of use). Moreover, the condition value can be used by the manager component to perform the maintenance procedure later than scheduled (e.g., condition of use translates into non-excessive use compared to a baseline amount of use). For instance, a baseline amount of use can be an average usage of the client asset, a manufacture defined usage of the client asset, a user defined usage of the client asset, among others. In general, the location of the use for the client asset can be a factor to consider when evaluating when a maintenance procedure is to be performed on the client asset. The condition of use for the client asset can be measured by at least one of an autonomous track recording systems, user input, location of use of the client asset, device that monitor wayside equipment, device that monitor a condition of the client asset, among others.

For example, a condition of a track can be “good” (e.g., without deficiencies on a rail system) or “bad” (e.g., with deficiencies on a rail system). Based on this assigned condition, the use of the client asset can be adjusted. It is to be appreciated that “good” or “bad” are solely for example and any ranking of the track can be used. In particular, a track recording data system (e.g., camera mounted on vehicle to monitor a rail condition) can be used to identify a condition of a rail system for a client asset.

The manager component can further assign a condition value to a client asset based on a degree of the use of the client asset. For example, a baseline revolutions per minute (RPM) can be used and a use for time above and/or below such baseline can be monitored. A duration of time above the RPM baseline can be used to adjust the scheduling of the maintenance procedure earlier (e.g., use excessive) and a duration of time below the RPM baseline can be used to adjust the scheduling of the maintenance procedure later (e.g., use not excessive). The degree of use can be measured by at least one of a revolution per minute (RPM), power output levels, speed, pressure, oil pressure, signal response time (e.g., communicating a signal to a client asset and an amount of time the client asset takes to communicate a response signal), a measurement of start and/or stopping within a duration of time, among others.

These conditions and factors used to determine the condition of a client asset can be displayed, stored, and/or used to generate an output for the system. In particular, the conditions and factors can be reported back to a user, fleet manager, railroad operator, and the like. The condition and/or status of the client asset can be displayed or stored as a table, a portion of a table, a graphic, an icon, and the like, wherein the condition and/or status of the asset is displayed based on a color change or other indicia.

It is to be appreciated that a maintenance procedure can be any suitable mechanical, electrical, cosmetic, or physical act performed on a client asset. For instance, a software or hardware update can be a maintenance procedure. In another example, a software reinstall can be a maintenance procedure. For instance, the maintenance procedure can be routine maintenance on a client asset, a repair on a client asset, an urgent repair on a client asset, a preventative maintenance procedure on a client asset, and the like.

In another example, the maintenance procedure can be at least one a scheduled maintenance procedure, an unscheduled maintenance procedure, a condition based maintenance procedure, a predictive based maintenance procedure, a non-critical fault maintenance procedure, a critical fault maintenance procedure, among others.

The manager component can schedule a maintenance procedure that is routine based on a “time in use” calculation, whereas the unscheduled maintenance procedure can be initiated by a trigger (e.g., user initiated, manufacturer recall, weather condition exposure, among others). The manager component can schedule a condition based maintenance procedure in which the signal could be from at least one of the client asset, the user, or from an external device (such as a wayside sensor). The manager component can schedule a predictive based maintenance procedure based on at least one of client asset data, maintenance data, condition information, performance data, historic data, and the like and compare against a model or a table that lists ‘time to fail.” The manager component can schedule a non-critical fault maintenance procedure based on a trigger (e.g., user input, user request, field order request, and the like). The manager component can schedule a critical maintenance procedure that schedules a location to perform the procedure and one or more workers, among others.

In another embodiment, the manager component can adjust a schedule to perform a maintenance procedure on a client asset if a current date/time is within a window of time (e.g., defined by user), wherein the adjustment is a “pull forward.” Thus, if “near to schedule” maintenance procedures are close in time, the system can “pull forward” near maintenance procedures.

This can be performed to reduce shop time (at the expense of the part usage that would be lost with the early replacement). For instance, when the client asset is having a first maintenance procedure performed on a date and a location, the manager component can evaluate a second maintenance procedure to determine if the second maintenance procedure can be performed on or around the date and the location already scheduled in order to decrease the number of times the client asset needs to be transported to the location for maintenance procedures. For instance, upon scheduling the first maintenance procedure, the location or worker assigned can be notified of the second maintenance procedure, wherein the location or worker assigned can determine to perform the second maintenance procedure. The manager component can further calculate a cost/benefit of doing the second maintenance procedure early.

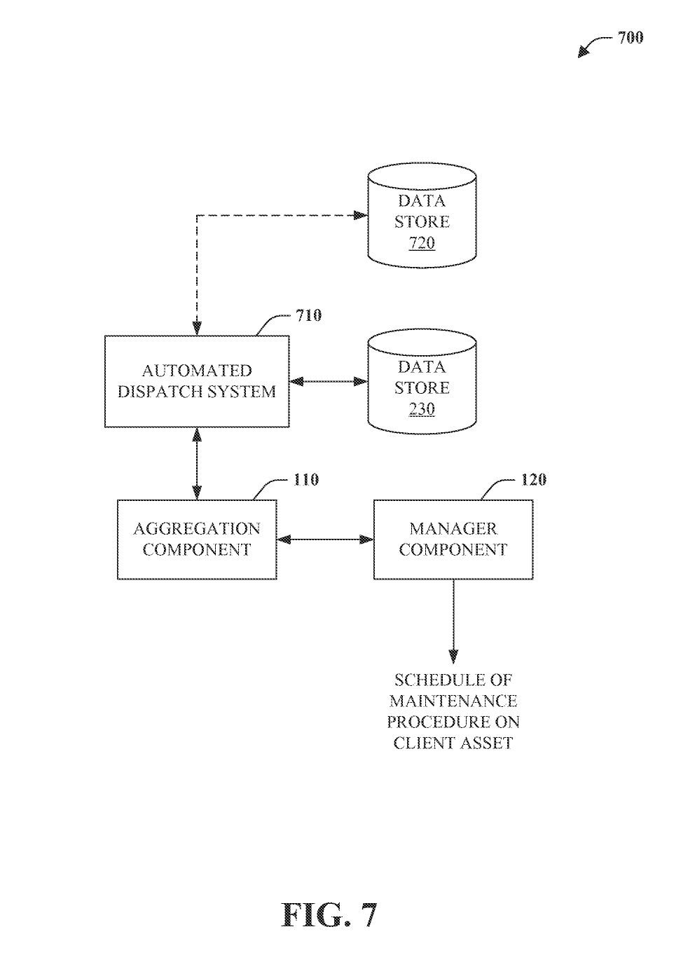

Turning to FIG. 7, a system 700 is illustrated that facilitates scheduling a maintenance procedure to perform on a client asset and/or assigning one or more workers to perform the maintenance procedure on the client asset on a date at a location. The manager component can evaluate data from one or more data sources in order to create an updated time interval to perform a maintenance procedure for a particular client asset. The updated time interval can be based on a comparison of a default interval (e.g., user defined or manufacturer defined) and a condition of the client asset. Based at least in part on the comparison, an updated time interval can be created to perform the maintenance procedure. In still another example, the updated time interval can be created to perform a type of maintenance procedure on a first client asset based on historical data, wherein the historical data is at least one of data associated with one or more maintenance procedures of the type performed on a second client asset, data associated with the type of maintenance procedure performed on the first client asset, data associated with a similar client asset, data associated with a similar type of maintenance, a combination thereof, and the like.

The system 700 further includes an automated dispatch system 710 that can be a computer-based dispatch system that collects, receives, and/or stores data related to a client asset and/or a railway system. It is to be appreciated that the automated dispatch system 710 can be selected with sound engineering judgment or by one of ordinary skill in the art without departing from the scope of the subject innovation. In particular, the automated dispatch system 710 can be a Unified Train Control System (UTCS), an archived database, a Precision Dispatch System (PDS), a Positive Train Control (PTC), among others. The automated dispatch system can access one or more databases such as, but not limited to, the data store 230 (discussed above). Data store 230 can include data such as client asset data, maintenance data, condition information, among others.

The automated dispatch system 710 can collect and/or receive data from (and transmit data to) one or more client assets such as a vehicle, a portion of a vehicle, a railway, a portion of a railway, a wayside equipment, a portion of a wayside equipment, signals, switches, a device monitoring a client asset, a device monitoring a vehicle, a device monitoring a railway, a device monitoring a wayside equipment, a sensor monitoring a client asset, a sensor monitoring a vehicle, a sensor monitoring a railway, a sensor monitoring a wayside equipment, and the like. It is to be appreciated that one or more networks can be used to communicate data between client assets and the automated dispatch system. The automated dispatch system 710 can collect and/or receive data from the client asset such as, but not limited to, client asset data, condition information, and/or maintenance data. It is to be appreciated that the aggregation component can be configured to collect and/or receive data from the automated dispatch system. However, it is to be appreciated that the system 700 can be configured in which the manager component communicates with the automated dispatch system to collect and/or receive data. Further, it is to be appreciated that the manager component and/or the aggregation component can be stand-alone components (as depicted) or integrated into the automated dispatch system.

In another embodiment, a user can upload or provide data to the automated dispatch system 710, wherein the user is at least one of a railway operator, a fleet manager, a worker, a dispatcher, among others. For instance, upon completion of the maintenance procedure on a client asset, a user can provide a status update (e.g., electronically) to the automated dispatch system 710 on the completion of such.

In still another embodiment, the automated dispatch system can collect and/or receive data via an additional data store 720, wherein data store 720 can be a weather service database, a field equipment manufacturer database, a database that receives operator communications, and the like. For instance, the data store 720 can include weather information for geographic locations in which a client asset is exposed. The data for the weather can include, but is not limited to include, hourly weather updates, geographic location, station weather, temperature, dew point, humidity, wind (e.g., direction, speed, gusts, etc.), temperature high, temperature low, precipitation, sunshine, cloud cover percentage, barometric pressure, horizontal visibility, possible sunshine, sunrise, sunset, among others.

The aforementioned systems, components, (e.g., aggregation component, manager component, real-time component, part predict component, labor predict component, HR component, scenario engine, automated dispatch system, among others), and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

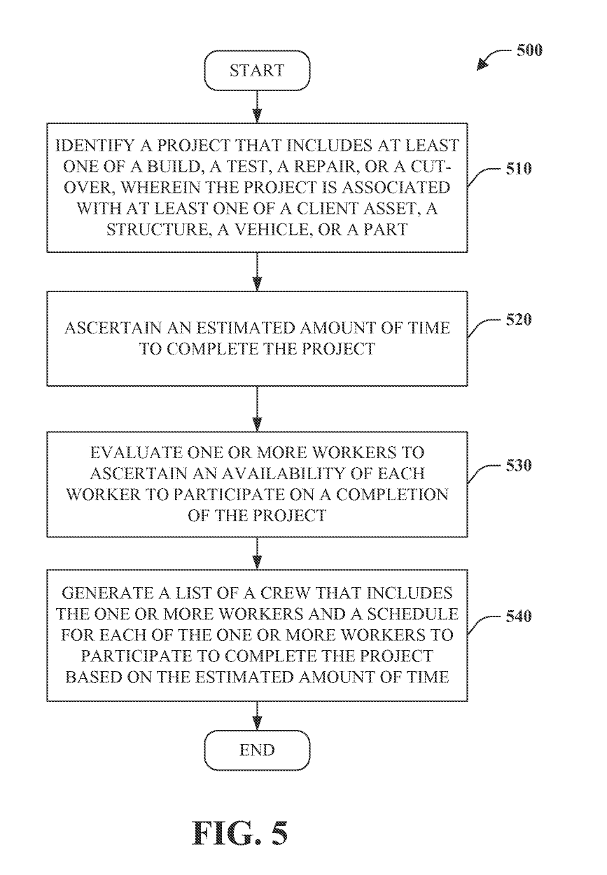

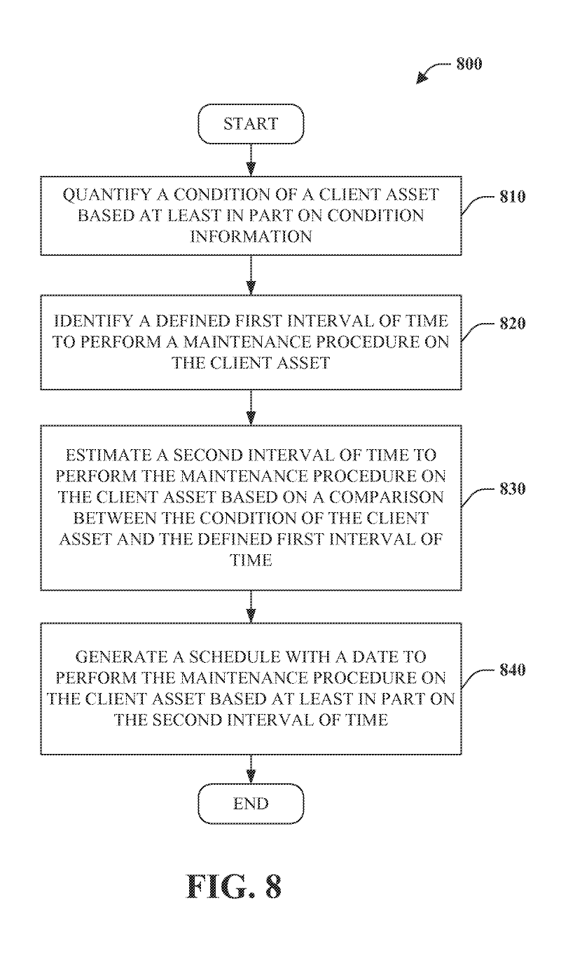

In view of the exemplary devices and elements described supra, methodologies that may be implemented in accordance with the disclosed subject matter are described with reference to the flow charts of FIGS. 5 and 8. The methodologies are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods described hereinafter. The methodologies can be implemented by a component or a portion of a component that includes at least a processor, a memory, and an instruction stored on the memory for the processor to execute.

FIG. 5 illustrates a flow chart of a method 500 for creating a schedule for one or more workers to participate on completing one or more projects based on information related to the project(s) and/or each worker. At reference numeral 510, a project that includes at least one of a build, a test, a repair, or a cutover can be identified, wherein the project is associated with at least one of a client asset, a structure, a vehicle, or a part. At reference numeral 520, an estimated amount of time to complete the project can be ascertained. At reference numeral 530, one or more workers can be evaluated to ascertain an availability of each worker to participate on a completion of the project. At reference numeral 540, a list of a crew can be generated that includes the one or more workers and a schedule for each of the one or more workers to participate to complete the project based on the estimated amount of time.

Turning to FIG. 8, a flow chart is illustrated of a method 800 for creating a schedule to perform a maintenance procedure on a client asset. At reference numeral 810, a condition of a client asset is quantified based at least in part on condition information. For instance, condition information can be, but is not limited to, client asset data, type of client asset, location of client asset, model information of the client asset, historic data related to maintenance procedures performed on the client asset, data representative of a parameter of the client asset, hours used, mega-watt hours, power produced, a metric to measure a use of the client asset, distance used, location of use for the client asset, weather conditions the client asset has experienced, cost to replace client asset, purchase price of the client asset, and the like. Moreover, a condition value of the client asset can be adjusted based on a type of use of the client asset or a location of the use of the client asset. Depending on such factors of use, the client asset condition can be adjusted. At reference numeral 820, a defined first interval of time can be identified to perform a maintenance procedure on the client asset. For instance, the defined first interval of time can be user defined or manufacturer defined for a particular maintenance procedure on a specific client asset. At reference numeral 830, a second interval of time can be estimated to perform the maintenance procedure on the client asset based on a comparison between the condition of the client asset and the defined first interval of time. For instance, a comparison between an amount of use of the client asset can be used to estimate a second interval of time to perform the maintenance procedure. At reference numeral 840, a schedule with a date can be generated to perform the maintenance procedure on the client asset based at least in part on the second interval of time.

In still another embodiment, the method can include assigning one or more workers to perform the maintenance procedure on the client asset at a location on the date. In still another embodiment, the method can include assigning the one or more workers to perform the maintenance procedure on the date, wherein the date takes into account an amount of time for one or more parts used in the maintenance procedure are delivered to the location.

In an embodiment, the method can further include obtaining a portion of employee information for one or more workers, and identifying a worker of the one or more workers to perform the maintenance procedure on the client asset on the date based at least in part on the portion of employee information. In an embodiment, the method can further include receiving the condition info for the client asset from a database or a device in communication with the client asset. In an embodiment, the method can further include generating the date based at least in part on weather conditions at a site of where the maintenance procedure is to be performed. In the embodiment, the maintenance procedure is at least one of a routine maintenance on the client asset, a repair on the client asset, an urgent repair on the client asset, or a preventative maintenance procedure on the client asset.

In an embodiment, the method can further include scheduling the maintenance procedure on the client asset based on an occurrence of a severe weather condition or a prediction of a severe weather condition. In an embodiment, the method can further include scheduling the maintenance procedure on the client asset based on at least one of a manufacturer defined procedure for the client asset or a portion of data from a user. In an embodiment, the method can further include identifying a part used to perform the maintenance procedure, ascertaining a delivery time of the part to a geographic location of where the maintenance procedure is to be performed, and generating the date to perform the maintenance procedure based on the delivery time of the part to the geographic location.

In an embodiment, the method can further include managing an inventory of one or more parts for the maintenance procedure, wherein the one or more parts are at least one of: ordered from a seller, shipped to a geographic location of where the maintenance procedure is to be performed, or shipped from a central receiving location associated with the client asset. In the embodiment, the method can further include identifying the one or more workers to perform the maintenance procedure based on the delivery time of the part. In the embodiment, the method can further include transmitting a condition of the client asset from onboard a vehicle.

In an embodiment, wherein the transmitting condition information comprises sending information from one or more of a sensor, a camera, a rail signal, or a rail switch to an offboard system (e.g., a backend system in an office facility) that analyzes the signal to determine the condition. In an embodiment, the method can further include communicating the date and the maintenance procedure to the one or more workers, and optionally logging a response from the one or more workers that is related to the communication.

In an embodiment, the client asset is one of a plurality of similar client assets, the method further comprising: evaluating two or more client assets of the plurality of client assets; and generating the updated interval of time to perform the maintenance procedure on the client asset based on the evaluation of two or more client assets or an average of the condition information as it is related to the maintenance procedure.

In an embodiment, a system can be provided wherein the second component is further configured to schedule the maintenance procedure for the client asset based on at least one of an occurrence of a severe weather condition, a prediction of a severe weather condition, or a maintenance request from a railroad operator. In the embodiment, the second component is further configured to generate a schedule with a date to perform the maintenance procedure on the client asset based at least in part on the second duration of time to perform the maintenance procedure. In the embodiment, the second component is further configured to assign one or more workers to perform the maintenance procedure on the client asset on the date. In the embodiment, the second component is further configured to adjust the date to perform the maintenance procedure based on a weather condition for a location of where the maintenance procedure is to be performed.

In an embodiment, a system is provided that includes means for quantifying a condition of a client asset based at least in part on condition information (e.g., via the aggregation component, the automated dispatch system, the manager component, among others). The system includes means for identifying a defined first interval of time to perform a maintenance procedure on the client asset (e.g., via the aggregation component, the automated dispatch system, the manager component, among others). The system includes means for estimating a second interval of time to perform the maintenance procedure on the client asset based on a comparison between the condition of the client asset and the defined first interval of time (e.g., via the aggregation component, the automated dispatch system, the manager component, among others). The system includes means for generating a schedule with a date to perform the maintenance procedure on the client asset based at least in part on the second interval of time (e.g., via the aggregation component, the automated dispatch system, the manager component, among others).

The method further may include evaluating weather for a geographic location of the project. The crew and the schedule may be based at least in part on the weather or a weather forecast. A portion of the employee information may be used in evaluating and assigning the crew and the schedule and may be based at least in part on the estimated amount of time and the portion of employee information. The employee information may relate to, for example, at least one of a shift schedule of the employee, a union requirement, an expertise of the employee, a geographic location of the employee, a suspension for the employee, a vacation time of the employee, an hourly rate of the employee, or an experience the employee may have from their work on a previous project. Other suitable items of employee information may include personal details, such as their vacation time, sick time, skill set, and the like.

The method may include evaluating project information and assigning the crew and respective schedule for each to participate on the project based on the estimated amount of time and the project information. The project information can relate to at least one of a geographic location of the project, a priority of the project, a cost of the project, a dispatch requirement of the project, a resource lead time for the project, a part related to the project, a shipment of a part for the project, and the like. The project information may relate to a completion time of the project, a start time of the project, an amount of time to complete the project, among others. The method may include identifying a part used to complete the project, ascertaining a delivery time of the part to a geographic location of the project, and/or assigning a portion of the crew based on the delivery time of the part.

The method may include managing an inventory of parts for projects based on the identified project, wherein the parts are at least one of ordered from a seller, shipped to a geographic location of the project, shipped from a central receiving location associated with the project, among others. The method may include assigning a crew with the schedule based on the inventory of parts for the project. The estimated amount of time can be adjusted based on the inventory of parts for the project. The schedule may include a start date for the project and a completion date for the project. The schedule or the list of the crew can be communicated to the one or more workers. The method may include receiving a query related to the estimated amount of time, the one or more workers, the availability of each worker, the project, an additional project, an additional worker, and the like. The method may also include generating an additional schedule for the project based on an evaluation of the query.

In an embodiment, a method can include estimating an amount of time to complete a project that includes at least one of a build, a test, or a cut-over, wherein the project is associated with at least one of a client asset, a structure, a vehicle, a part, or a system, ascertaining an availability of one or more workers to participate on the project, and generating both a list of a crew that includes the one or more workers and a schedule for the one or more workers to participate on the project based at least in part on the estimated amount of time. In an embodiment, the method can include assigning the crew and the schedule based at least in part on a portion of employee information.

In an embodiment, the method can include associating the employee information with at least one of a shift schedule of an employee, a union requirement, an efficiency rating of the employee, a geographic location at a defined time of the employee, a suspension status for the employee, a vacation time of the employee, an hourly rate of the employee, an expertise level of the employee, or an experience by the employee while on a previous project, wherein the employee is one of the one or more workers.

In an embodiment, the method can include assigning the crew and the schedule based at least in part on weather conditions at a site of the project. In an embodiment, the method can include assigning the crew and the schedule based on a portion of project information of the project. In an embodiment, the method can include associating the project information to at least one of a geographic location or site of the project, a priority of the project, a cost of the project, a dispatch requirement of the project, a resource lead time for the project, a part related to the project, or a shipment delivery date of a part for the project. In an embodiment, the method can include project information being related to at least one of a completion time of the project, a start time of the project, or an amount of time to complete the project.

In an embodiment, the method can include identifying a part used to complete the project, ascertaining a delivery time of the part to a geographic location of the project, and assigning at least a portion of the crew based on the delivery time of the part. In an embodiment, the method can include managing an inventory of one or more parts for the project, wherein the one or more parts are at least one of: ordered from a seller, shipped to a geographic location of the project, or shipped from a central receiving location associated with the project. In an embodiment, the method can include assigning a portion of the crew with the schedule based on the inventory of one or more parts for the project. In an embodiment, the method can include adjusting the estimated amount of time based on the inventory of one or more parts for the project.

In an embodiment, the method can include the schedule that includes a start date for the project and a completion date for the project, and further comprising bounding the estimating of the time based at least in part on the start date or the completion date. In an embodiment, the method can include communicating at least one of the schedule or the list of the crew to the one or more workers, and optionally logging a response from the one or more workers that is related to the communication. In an embodiment, the method can include receiving a query related to at least one of the estimated amount of time, the one or more workers, the availability of each worker, the project, an additional project, or an additional worker, and generating at least an additional schedule for the project based on an evaluation of the query.

In an embodiment, a method can include a first component configured to evaluate at least one of a project or a disparate project to ascertain a number of workers to assign, one or more parts for the project, and a completion date, wherein the disparate project is completed or on-going, and a second component configured to create a schedule for the project, wherein the schedule assigns one or more workers to the project for one or more dates based on the number of workers to assign and the completion date.

In an embodiment, the system can include a third component configured to at least one of the following: identify a delivery time to a geographic location for the project; and manage an inventory for the one or more parts of the project. In an embodiment, the system can include the second component that is further configured to adjust at least one of the schedule or the assignment of the one or more workers based on the delivery time.

In an embodiment, the system can include the second component that is further configured to adjust at least one of the schedule or the assignment of the one or more workers based on a weather condition for a geographic location proximate to a location for the project. In an embodiment, the system can include the second component that is further configured to adjust at least one of the schedule or the assignment of the one or more workers based on at least one of a shift schedule of the employee, a union requirement, an expertise of the employee, a geographic location of the employee, a suspension for the employee, a vacation time of the employee, an hourly rate of the employee, or an experience on a previous project.

In an embodiment, a system is provided that includes means for identifying a project that includes at least one of a build, a test, or a cut-over, wherein the project is associated with at least one of a client asset, a structure, a vehicle, or a part, means for ascertaining an estimated amount of time to complete the project, means for evaluating one or more workers to ascertain an availability of each worker to participate on a completion of the project, and means for generating a list of a crew that includes the one or more workers and a schedule for each of the one or more workers to participate to complete the project based on the estimated amount of time.

In another embodiment, a method comprises automatically quantifying, with one or more processors, a condition of a client asset based at least in part on condition information. (For example, the condition information may be received by the one or more processors from one or more sensors, from another type of input/output device, from a database, over a wireless communication link, etc.) The method further comprises automatically identifying, with the one or more processors, a defined first interval of time to perform a maintenance procedure on the client asset. The method further comprises automatically estimating, with the one or more processors, a second interval of time to perform the maintenance procedure on the client asset based on a comparison between the condition of the client asset and the defined first interval of time. The method further comprises automatically generating, with the one or more processors, a schedule with a date to perform the maintenance procedure on the client asset based at least in part on the second interval of time.

In another embodiment of the method, the method further comprises automatically communicating, under the control of the one or more processors, the schedule, responsive to which at least one of the client asset or one or more vehicles are moved for the maintenance procedure to be performed (e.g., the client asset may be moved to a maintenance facility, and/or the one or more vehicles may be moved to the maintenance facility and/or to a location of the client asset other than the maintenance facility for purposes of transporting maintenance personnel, parts, maintenance equipment, etc.) In one embodiment, the client asset and/or the one or more vehicles are configured to automatically move responsive to the schedule, e.g., one of the client asset and/or the one or more vehicles may include a vehicle control system that is configured to automatically control the vehicle for movement based on received schedules, including the received schedule for the maintenance procedure.

In another embodiment, a method comprises automatically generating condition information of a client asset, responsive to operation of the client asset. That is, the client asset is operated (e.g., moved), and as the client asset is operated, the condition information of the client asset in operation is automatically generated, such as by a sensor operably coupled to the client asset. The condition information is automatically communicated and received by one or more processors. The method further comprises automatically quantifying, with the one or more processors, a condition of the client asset based at least in part on the condition information. The method further comprises automatically identifying, with the one or more processors, a defined first interval of time to perform a maintenance procedure on the client asset. The method further comprises automatically estimating, with the one or more processors, a second interval of time to perform the maintenance procedure on the client asset based on a comparison between the condition of the client asset and the defined first interval of time. The method further comprises automatically generating, with the one or more processors, a schedule with a date to perform the maintenance procedure on the client asset based at least in part on the second interval of time. The method may further comprise automatically communicating, under the control of the one or more processors, the schedule, responsive to which at least one of the client asset or one or more vehicles are moved for the maintenance procedure to be performed (e.g., the client asset may be moved to a maintenance facility, and/or the one or more vehicles may be moved to the maintenance facility and/or to a location of the client asset other than the maintenance facility for purposes of transporting maintenance personnel, parts, maintenance equipment, etc.) In one embodiment, the client asset and/or the one or more vehicles are configured to automatically move responsive to the schedule, e.g., one of the client asset and/or the one or more vehicles may include a vehicle control system that is configured to automatically control the vehicle for movement based on received schedules, including the received schedule for the maintenance procedure.

In another embodiment, a system comprises a first component and a second component. The first and second components may comprise one or more processors. The first component is configured to automatically identify a maintenance procedure to perform on a client asset at a defined first duration of time based on a condition of the client asset that is quantified based at least in part on condition information. The first component is further configured to automatically compare the condition of the client asset with the defined first duration of time to create a second duration of time. The second component is configured to automatically create a schedule with a date to perform the maintenance procedure on the client asset at the second duration of time based on the comparison of the first component or a portion of historic data representative of when the maintenance procedure was performed on two or more client assets.

In another embodiment of the system, one of the first component or the second component is configured to automatically control communication of the schedule, responsive to which at least one of the client asset or one or more vehicles are moved for the maintenance procedure to be performed (e.g., the client asset may be moved to a maintenance facility, and/or the one or more vehicles may be moved to the maintenance facility and/or to a location of the client asset other than the maintenance facility for purposes of transporting maintenance personnel, parts, maintenance equipment, etc.) In one embodiment, the client asset and/or the one or more vehicles are configured to automatically move responsive to the schedule, e.g., one of the client asset and/or the one or more vehicles may include a vehicle control system that is configured to automatically control the vehicle for movement based on received schedules, including the received schedule for the maintenance procedure.

In the specification and claims, reference will be made to a number of terms that have the following meanings The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method, comprising:
quantifying a condition of a client asset based at least in part on condition information;
identifying a defined first interval of time to perform a maintenance procedure on the client asset;
estimating a second interval of time to perform the maintenance procedure on the client asset based on a comparison between the condition of the client asset and the defined first interval of time; and
generating a schedule with a date to perform the maintenance procedure on the client asset based at least in part on the second interval of time.

2. The method of claim 1, further comprising obtaining a portion of employee information for one or more workers, and identifying a worker of the one or more workers to perform the maintenance procedure on the client asset on the date based at least in part on the portion of employee information.

3. The method of claim 2, further comprising receiving the condition information for the client asset from at least one of a database or a device in communication with the client asset.

4. The method of claim 1, further comprising generating the date based at least in part on weather conditions at a site of where the maintenance procedure is to be performed.

5. The method of claim 1, wherein the maintenance procedure is at least one of a routine maintenance on the client asset, a repair on the client asset, an urgent repair on the client asset, or a preventative maintenance procedure on the client asset.

6. The method of claim 5, further comprising:
identifying a part used to perform the maintenance procedure;
ascertaining a delivery time of the part to a geographic location of where the maintenance procedure is to be preformed; and
generating the date to perform the maintenance procedure based on the delivery time of the part to the geographic location.

7. The method of claim 1, further comprising generating the schedule for schedule the maintenance procedure on the client asset based on at least one of an occurrence of a severe weather condition or a prediction of a severe weather condition.

8. The method of claim 1, further comprising generating the schedule for the maintenance procedure on the client asset based on at least one of a manufacturer defined procedure for the client asset or a portion of data from a user.

9. The method of claim 1, further comprising managing an inventory of one or more parts for the maintenance procedure, wherein the one or more parts are at least one of: ordered from a seller, shipped to a geographic location of where the maintenance procedure is to be performed, or shipped from a receiving location associated with the client asset.

10. The method of claim 9, further comprising identifying the one or more workers to perform the maintenance procedure based on a delivery time of the one or more parts to the geographic location of where the maintenance procedure is to be performed.

11. The method of claim 1, further comprising receiving the condition information of the client asset from onboard a vehicle.

12. The method of claim 1, further comprising transmitting condition information which comprises sending information from one or more of a sensor, a camera, a rail signal, or a rail switch to an offboard system that analyzes the signal to determine the condition.

13. The method of claim 1, further comprising communicating the date and the maintenance procedure to the one or more workers, and logging a response from the one or more workers that is related to the communication.

14. The method of claim 1, wherein the client asset is one of a plurality of similar client assets, the method further comprising:
evaluating two or more client assets of the plurality of client assets; and
generating the second interval of time to perform the maintenance procedure on the client asset based on the evaluation of the two or more client assets or an average of the condition information as it is related to the maintenance procedure.

15. A system comprising:
a first component configured to identify a maintenance procedure to perform on a client asset at a defined first duration of time based on a condition of the client asset that is quantified based at least in part on condition information;
the first component is further configured to compare the condition of the client asset with the defined first duration of time to create a second duration of time; and
a second component configured to create a schedule with a date to perform the maintenance procedure on the client asset at the second duration of time based on the comparison of the first component or a portion of historic data representative of when the maintenance procedure was performed on two or more client assets.

16. The system of claim 15, wherein the second component is further configured to create the schedule to perform the maintenance procedure on the client asset based on at least one of an occurrence of a severe weather condition, a prediction of a severe weather condition, or a maintenance request from a railroad operator.

17. The system of claim 15, wherein the second component is further configured to create the schedule with a date to perform the maintenance procedure on the client asset based at least in part on the second duration of time to perform the maintenance procedure.

18. The system of claim 17, wherein the second component is further configured to assign one or more workers to perform the maintenance procedure on the client asset on the date.

19. The system of claim 17, wherein the second component is further configured to adjust the date to perform the maintenance procedure based on a weather condition for a location of where the maintenance procedure is to be performed.

20. A system, comprising:
means for quantifying a condition of a client asset based at least in part on condition information;
means for identifying a defined first interval of time to perform a maintenance procedure on the client asset;
means for estimating a second interval of time to perform the maintenance procedure on the client asset based on a comparison between the condition of the client asset and the defined first interval of time; and
means for generating a schedule with a date to perform the maintenance procedure on the client asset based at least in part on the second interval of time.
